(19) United States
(12) Patent Application Publication
(10) Pub. No.: US 2015/0362197 A1
(43) Pub. Date: Dec. 17, 2015

(54) ROOF BLANKETING DEVICE

(71) Applicant: Charmyne Fluker, Greensboro, NC (US)

(72) Inventor: Charmyne Fluker, Greensboro, NC (US)

(21) Appl. No.: 14/739,180

(22) Filed: Jun. 15, 2015

Related U.S. Application Data
(60) Provisional application No. 62/011,753, filed on Jun. 13, 2014.

(51) Int. Cl. F24D 13/02; F24D 19/02; H05B 3/03; E04D 13/10

(52) U.S. Cl. CPC F24D 13/02; E04D 13/103; F24D 19/0203; H05B 3/03

(57) ABSTRACT

A roof blanketing device to cover a roof of a structure that includes: a covering, where the covering extends over the roof; a plurality of thermal electrodes within the covering, where the plurality of thermal electrodes is distributed throughout the covering; a means to secure the covering along a bottom edge of the covering; and a second means to secure the covering against a ridge of the roof. The means to secure may include an O-ring, which receives a hook with a weight attached. Further, the second means to secure includes at least one of hook and loop fasteners, zippers, magnets or hook and eye connectors. In one particular embodiment, the covering includes a top edge, a bottom edge and two lateral edges.

### CROSS REFERENCE TO OTHER APPLICATIONS

This application claims priority to U.S. Provisional Application Ser. No. 62/011,753 filed on Jun. 13, 2014.

### BACKGROUND OF THE INVENTION

1. Field of the Invention

The present invention relates to a device that is positioned over the roof of a structure to better remove snow buildup and maintain roof structure stability during snow storms.

2. Description of Related Art

Snowfall is a distinct feature of winter, welcomed by many as an indicator of the holidays and fun winter sports. While these storms indicate fun to be had after the fall, they are also worrisome for others. Snow and ice buildup is a common problem for individuals living in areas with heavy, wet snowfall. The weight of the snow, ice and water may cause damage to rooftops like those on a house, office building or parking structure. If too much weight is accumulated the roof may crack, leak or even collapse. This is very problematic for homeowners and insurance companies having to continuously pay for repairs and replacement.

Another problem commonly associated with heavy snowfall is sliding ice sheets. When snow and ice buildup on a roof, the weight may cause a section of the accumulation to break away and slide down the roof. The ice sheets may cause damage to any structures in their path. Gutters, patios, furniture and decks may all be damaged by the heavy, sliding snow. With all the damage and destruction caused by snow and ice accumulation, it would be beneficial in the art to provide a way to clear the snow before it builds up and causes structural damage. It would also be desirable in the art to provide a device that securely attaches to a roof so storm winds will not blow the device off the roof.

### SUMMARY OF THE INVENTION

The present invention relates to a roof blanketing device to cover a roof of a structure that includes: a covering, where the covering extends over the roof; a plurality of thermal electrodes within the covering, where the plurality of thermal electrodes is distributed throughout the covering; a means to secure the covering along a bottom edge of the covering; and a second means to secure the covering against a ridge of the roof. The means to secure may include an O-ring, which receives a hook with a weight attached. Further, the second means to secure includes at least one of hook and loop fasteners, zippers, magnets or hook and eye connectors. In one particular embodiment, the covering includes a top edge, a bottom edge and two lateral edges.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a roof blanketing device in accordance with an exemplary embodiment of the present invention; and

FIG. 2 depicts an enlarged view of a securing means in accordance with an exemplary embodiment of the present invention.

Like reference numerals refer to like parts throughout the description of several views of the drawings.

### DETAILED DESCRIPTION OF THE DRAWINGS

The present invention relates to a device that stretches a roof as a means to remove snow buildup and maintain roof stability during a snowstorm. The present invention relates a roof-blanketing device to prevent snow and ice buildup on rooftops. The roof-blanketing device includes a covering that extends over a roof structure. The roof blanket includes thermal electrodes incorporated within the material to melt snow and prevent snow and/or ice accumulation. The roof blanket may be secured against the roof with weights around the edging to avoid any shifting during a storm. The roof-blanketing device provides peace of mind to the user and helps to prevent damage to the user's roof during a snowstorm.

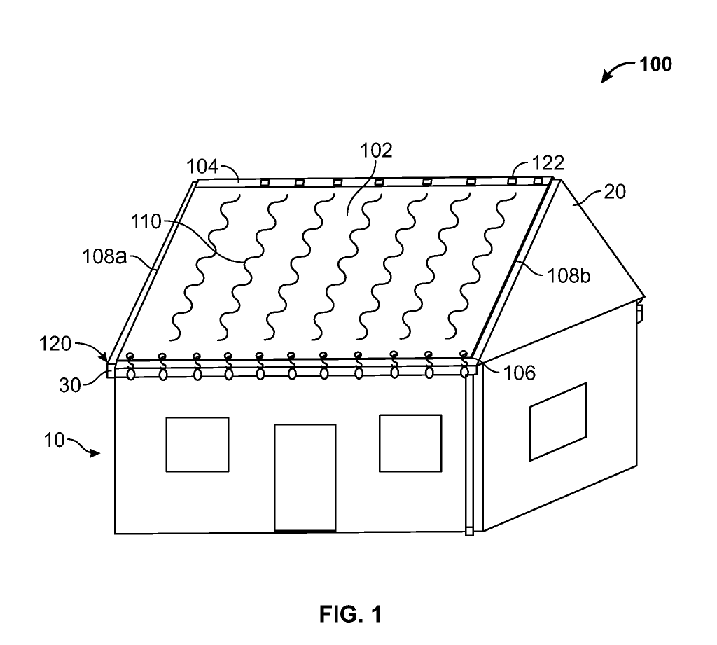

Turning now descriptively to the drawing, referring to FIG. 1, a perspective view of a roof blanketing device 100 in accordance with an exemplary embodiment of the present invention. The roof blanketing device 100 includes a covering 102 that extends over a roof 20 of a structure 10. The structure 10 may be a house, apartment building, office building, garage, barn or other edifice with a roof that may need protection. The covering 102 may be a waterproof, tarp-like material that withstands tearing but yet is flexible enough to conform to a variety of roof materials. The covering 102 includes a top edge 104 to cover a ridge, a bottom edge 106 to meet the gutter 30, and lateral edges 108a, 108b. The covering 102 may be a continuous piece of material that blankets the entire roof 20 or it may be sectionalized to cover each flat section of roof, meeting the next section at the ridges.

Preferably, the covering 102 includes a plurality of thermal electrodes 110 evenly distributed throughout the covering 102. The thermal electrodes 110 heat the surface of the covering 102 to prevent snow and ice from settling on the roof 20. Upon melting, the ice, snow and/or water slide off the covering 102 to deposit within the gutters 30 of the structure 10. The gutters 30 consequently drain the water away from the roof 20. The heated covering 102 prevents snow from accumulating and is safely removed from the roof 20. The thermal electrodes 110 may be activated with a power pack positioned within the structure 10. The overall thickness of the covering 102 may vary to accommodate more extreme winter conditions.

A means 120 to secure secures the covering 102 over the roof 20. The means 120 to secure secures the bottom edge 106 of the covering 102 to prevent flapping and shifting during a storm. The covering 102 may also include a second means 122 to secure secures the covering 102 against the ridge. Additionally, the second means 122 to secure may secure sectional pieces of the covering 102 to each other. The second means 122 to secure may be hook and loop fasteners, zippers, magnets, hook and eyes or the like.

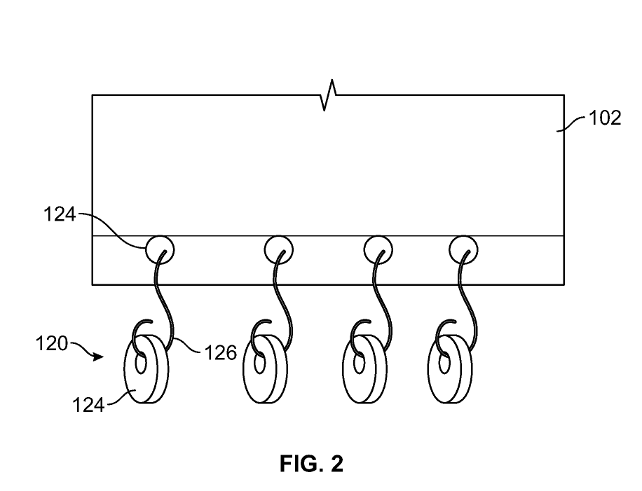

Referring now to FIG. 2, an enlarged view of the means 120 to secure is shown in accordance with an exemplary embodiment of the present invention. The means 120 to secure align along the bottom edge of the covering 102. The means 120 to secure may include an eye 124 or O-ring through which a hook 126 is threaded. The hook 126 may be S-shaped to provide a curve through which a weight 128 is attached. The hook 126 may position the weight 128 in front of or within the gutter to ensure that the melted snow flows toward the gutter during the storm. The roof-blanketing device 100 is a useful product that is enables the melting of ice or snow on a rooftop by aligning secure thermal electrodes that melt and direct the water off the roof thereby preventing any subsequent harm of damage to the structure during a storm.

In another exemplary embodiment, the roof-blanketing device 100 includes a thermostat control system, where a thermostat is installed within the roof-blanketing device 100. The thermostat may include a wireless connection with a communications system so that a user may remotely control the temperature of the roof-blanketing device 100. In one exemplary embodiment, the remote control features may be operated over a smartphone through an application installed on the smartphone.

Other applications of the present invention may include the following. The covering 102 may be modified in shape and configuration so the covering 102 may be applied over an airplane wing, windshield, propeller or nose of the plane. Such a use could expedite the operation of airplanes in winter conditions. The further the covering 102 may be applied over stadium seats to provide warm for spectator at a sporting event. Further the covering 102 may be applied to a wheel of a vehicle that is parked during a winter storm.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A roof blanketing device to cover a roof of a structure comprising:
a. a covering, where the covering extends over the roof;
b. a plurality of thermal electrodes within the covering, where the plurality of thermal electrodes is distributed throughout the covering;
c. a means to secure the covering along a bottom edge of the covering; and
d. a second means to secure the covering against a ridge of the roof.

2. The roof blanketing device according to claim 1, where the means to secure includes an o-ring which receives a hook with a weight attached.

3. The roof blanketing device according to claim 1, where the second means to secure includes at least one of hook and loop fasteners, zippers, magnets or hook and eye connectors.

4. The roof blanketing device according to claim 1, where the covering includes a top edge, a bottom edge and two lateral edges.

5. The roof blanketing device according to claim 1, where the covering includes a power pack integrated within the covering to supply power to the plurality of thermal electrodes.

6. The roof blanketing device according to claim 1, where the covering includes a thermostat control system, where the thermostat control controls the temperature of the plurality of thermal electrodes.
